(19) United States
(12) Patent Application Publication
(10) Pub. No.: US 2007/0072619 A1
(43) Pub. Date: Mar. 29, 2007

(54) Method and system for generating automated location indicating responses

(76) Inventors: Lu Wei, Tokyo (JP); Michihiro Miura, Yokohama (JP)

Correspondence Address: MOTOROLA INC, 600 NORTH US HIGHWAY 45, ROOM AS437, LIBERTYVILLE, IL, 60048-5343, US

(21) Appl. No.: 11/236,333

(22) Filed: Sep. 27, 2005

(51) Int. Cl. H04Q 7/20

(52) U.S. Cl. 455/456.1

(57) ABSTRACT

A method and system for generating an automated location-indicating response to a call is useful for identifying a present location of a callee mobile device. The method includes receiving a call, transmitted from a caller device, at a callee mobile device (step 305). An automated response to the call is then generated, the response including location data that indicate a present location of the callee mobile device (step 320).

### FIELD OF THE INVENTION

The present invention relates generally, but not exclusively, to automated location-indicating electronic responses to telephone calls.

### BACKGROUND OF THE INVENTION

Electronic devices such as mobile phones, personal digital assistants (PDAs) and notebook computers are now ubiquitous and enable people to communicate with other people from remote and diverse environments. For example telephone calls using mobile phones are frequently placed and received from almost anywhere including moving busses and cars, parks, restaurant tables and elevators. Further, email is often sent and received using notebook computers or handheld devices in varied locations such as airplanes and other public transport vehicles.

In part because of the increased ease and convenience of mobile communications, the average number of mobile communications received by mobile phone users has also increased. However, the increased number of calls to mobile devices also means that an increased number of calls do not go through, because either a called mobile device is switched off or a callee is unavailable or otherwise unable to answer a call. For example, many governments have restrictions on the use of “hands on” mobile phones by a driver of a vehicle. Thus drivers must either use “hands free” mobile phones while driving or defer answering calls that are received while driving.

Instant and accurate geographic location data is a further feature provided by many mobile electronic devices. Many handheld devices are able to access location data from the Global Positioning System (GPS) or from other mobile location systems, and couple the data with Geographic Information System (GIS) data. The combined location/GIS services are then employed for example in handheld navigation and locating systems.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating a radio communications device in the form of a radio telephone that performs the present invention;

FIG. 2 is a schematic diagram of a communication system according to an embodiment of the present invention; and

FIG. 3 is a generalized flow diagram illustrating the steps of a method for generating an automated location-indicating response according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a method and system for generating automated location-indicating responses to a call. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

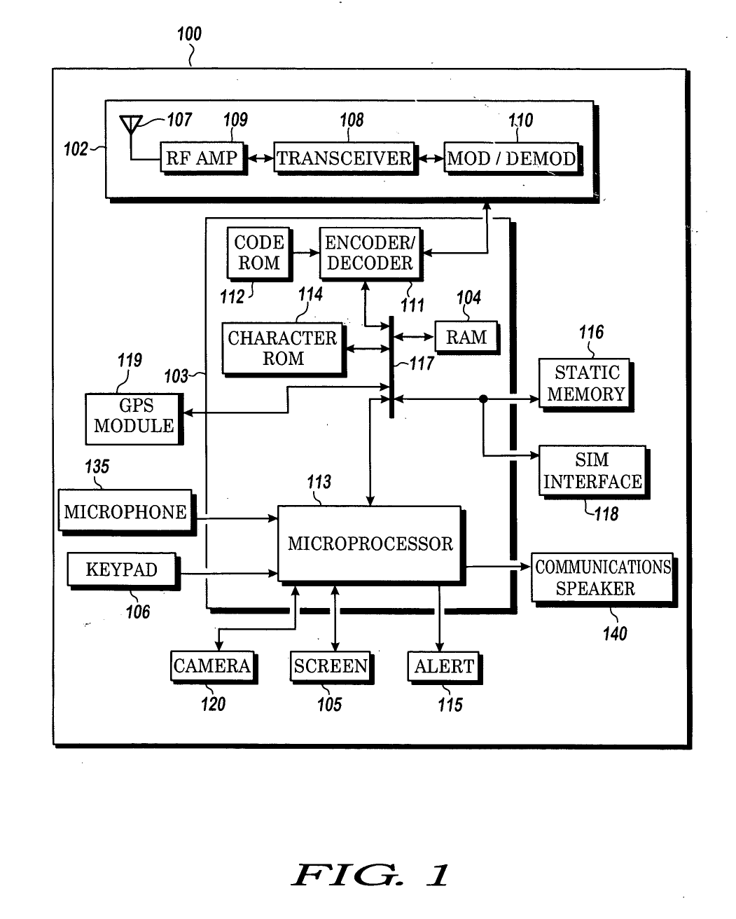

Referring to FIG. 1, there is a schematic diagram illustrating a typical radio communications device in the form of a radio telephone 100 comprising a radio frequency communications unit 102 coupled to be in communication with a processor 103. The radio telephone 100 also has a display screen 105, a keypad 106 and a camera 120 coupled to be in communication with the processor 103. As will be apparent to a person skilled in the art, the screen 105 may be a touch screen thereby making the keypad 106 optional.

The processor 103 includes an encoder/decoder 111 with an associated code Read Only Memory (ROM) 112 storing data for encoding and decoding voice or other signals that may be transmitted or received by the radio telephone 100. The processor 103 also includes a micro-processor 113 coupled, by a common data and address bus 117, to the encoder/decoder 111, a character Read Only Memory (ROM) 114, a Random Access Memory (RAM) 104, static programmable memory 116 and a SIM interface 118. The static programmable memory 116 and a SIM (often called a SIM card) operatively coupled to the SIM interface 118 each can store, amongst other things, selected incoming text messages and a Telephone Number Database TND (phonebook) comprising a number field for telephone numbers and a name field for identifiers associated with one of the numbers in the name field. For instance, one entry in the Telephone Number Database TND may be 91999111111 (entered in the number field) with an associated identifier “Steven C! at work” in the name field. The SIM card and static memory 116 may for example also store data from an electronic calendar associated with a user of the phone 100. Also operatively connected to the bus 117 is a Global Positioning System (GPS) module 119 that includes a transceiver and other appropriate GPS circuitry.

The micro-processor 113 has ports for coupling to the screen 105, keypad 106 and camera 120, and an alert 115 that typically contains an alert speaker, vibrator motor and associated drivers. Also, micro-processor 113 has ports for coupling to a microphone 135 and communications speaker 140. The character Read Only Memory 114 stores code for decoding or encoding text messages that may be received by the communications unit 102. In this embodiment the character Read Only Memory 114 also stores operating code (OC) for the micro-processor 113 and code for performing functions associated with the radio telephone 100.

The radio frequency communications unit 102 is a combined receiver and transmitter having a common antenna 107. The communications unit 102 has a transceiver 108 coupled to antenna 107 via a radio frequency amplifier 109. The transceiver 108 is also coupled to a combined modulator/demodulator 110 that couples the communications unit 102 to the processor 103.

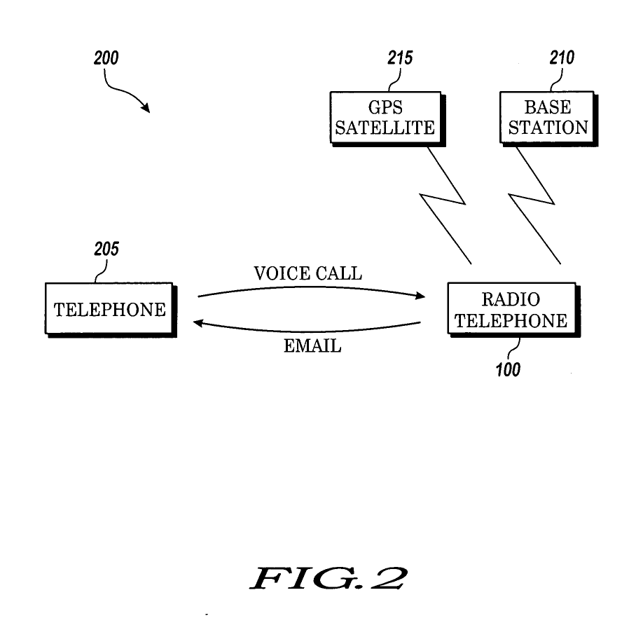

Referring to FIG. 2 there is a schematic diagram of a communication system 200 according to an embodiment of the present invention. The system 200 operates as follows. A caller device such as a telephone 205 initiates a voice call to a callee mobile device such as the radio telephone 100. If a user of the callee mobile device is unable to answer the call, the callee device generates an automated response to the call including location data that indicates a present location of the callee device.

For example, when a voice call is received at the radio telephone 100, a user of the phone 100 can have the phone 100 set to automatically generate a location-indicating response to the call. The phone 100 can acquire its precise location using, for example, mobile positioning data from mobile base stations 210 or from GPS satellites 215 communicating with the GPS module 119. A user of the callee phone 100 can record a pre-drafted text message in a memory of the phone 100, such as the static programmable memory 116, which message includes variables concerning location data. An example of such a pre-drafted message may thus read “I am currently at {address variable} and am unable to take your call”. The generated response then includes real-time location data merged with the pre-drafted text message, so that the transmitted response in the above example may read “I am currently at 2028 Main Boulevard and am unable to take your call.”

An automated response to a caller can be transmitted in various ways according to different embodiments of the present invention. For example the response can be included in an email, where an address for the email is associated with the caller's telephone number in an electronic address book of the callee phone 100. The caller may then access and read the email either directly from the caller device, if the caller device is capable of receiving emails, or from another device. The automated response also can be sent in other ways such as using a Short Messaging System (SMS) format.

Other embodiments of the present invention may merge additional information into a pre-drafted text message. For example, the callee phone 100 may be programmed, when generating an automated location-indicating response, to access the callee's electronic calendar that is stored on the phone 100. Data from the calendar then can be used to provide a more detailed response. For example, such a response may read “I am presently at a {activity variable} in {address variable} and am unable to take your call. I should be finished by {free-time variable} and will return your call then.” Here the address variable is generated using the location indicating techniques described herein, and the activity variable and free-time variable are retrieved from a callee's electronic calendar. Thus a completed response may read “I am presently at a shareholder's meeting in New York City and am unable to take your call. I should be finished by 4:00 pm and will return your call then.” An address variable according to the present invention may yield a general address such as a city name or a specific address such as a street address number, or even the identity of a nearby landmark, depending on a level of location detail that a callee desires to provide to a caller.

A location-indicating automated response of the present invention can be generated based on various criteria. For example a user of the callee phone 100 can program the phone 100 to generate and transmit a response after a predetermined time period, such as when the phone 100 is not answered after a given number of “rings”, or alternatively the response can be generated and transmitted immediately if the user has set a callee unavailable flag on the phone 100 that activates for all received calls the automated response feature of the phone 100. Further, the phone 100 can be programmed to select a specific response based on an identity associated with the caller mobile device. For example calls received from only designated individuals or groups of individuals, such as individuals who are listed as “family” in an electronic address book associated with the phone 100, may receive an automated response to a call that includes detailed location information (e.g., “I am at {specific address}”); whereas other callers may receive an automated response that includes only general location information (e.g., “I am currently away from the office”). Also, a phone 100 can be programmed to generate a location-indicating response according to the present invention regardless whether a call is answered. For example a phone 100 owned by a child can be programmed according to the present invention to provide specific location information to the child's parents, whether the child answers a call from the parents or not, and programmed not to transmit location information to any other callers.

According to a further embodiment of the present invention, a callee phone 100 can be programmed to take a picture, using the camera 120, whenever an automated location-indicating response is generated. The resulting image data are then transmitted to the caller with the automated response. Such a feature can be useful for example where drivers of delivery trucks routinely mount their mobile phones 100, when not in use, in dashboard-mounted cradles. Dispatchers of such trucks are then able to obtain a near instantaneous image through the windshield of a given truck simply by calling the truck's driver. Those skilled in the art will also recognize that the camera 120 may be a device separate from the phone 100, but operatively connected to the phone 100 using a wired or wireless connection.

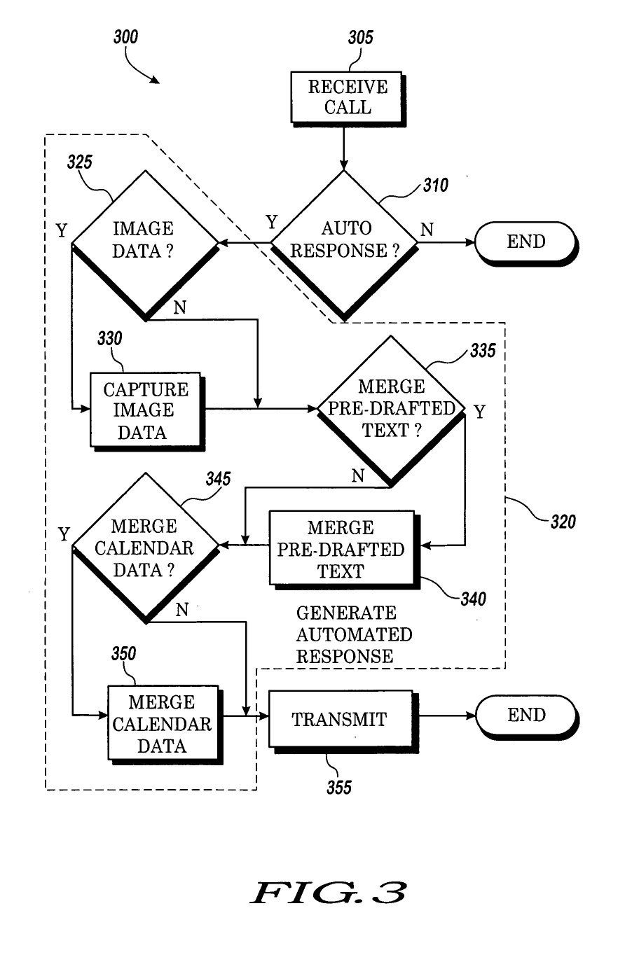

Referring to FIG. 3 there is a generalized flow diagram illustrating the steps of a method 300 for generating an automated location-indicating response according to an embodiment of the present invention. The method 300 is performed by the phone 100. First, at step 305 a call, transmitted from a caller device (such as a phone 205), is received at a callee mobile device (such as a radio telephone 100). At step 310 it is then determined whether an automated response feature of the callee device is set to activate. If not, the process ends. If the response feature is set to activate, then at step 320 an automated response including location data that indicate a present location of the callee mobile device is generated according to the teachings of the present invention.

The automated response generated at step 320 may include various sub-steps as illustrated in FIG. 3. For example, at step 325 it may be determined whether image data should be transmitted with the response. If so, then at step 330 such image data are captured by the camera 120. At step 335 it may be determined whether a pre-drafted text message should be merged with the response. If so, then at step 340 the location data are merged with the pre-drafted text. At step 345 it may be determined whether calendar data should be merged with the response. If so, then at step 350 the calendar data are merged with the response. Finally, at step 355, the response is transmitted to the caller using for example email or an SMS.

Advantages of embodiments of the present invention thus include the ability to quickly and conveniently transmit the location of a mobile device in response to a call. People such as parents and their children, salespeople, delivery personnel, maintenance personnel, managers, construction workers, etc. can thus employ their mobile devices to immediately inform others of their present location when a call cannot be answered. Automated responses can be transmitted using various means including email and SMS formats and can include features such as images, pre-drafted text messages and calendar data.

It will be appreciated that embodiments of the invention described herein may be comprised of one or more conventional processors and unique stored program instructions that control the one or more processors to implement, in conjunction with certain non-processor circuits, some, most, or all of the functions of generating an automated location-indicating response to a call as described herein. The non-processor circuits may include, but are not limited to, a radio receiver, a radio transmitter, signal drivers, clock circuits, power source circuits, and user input devices. As such, these functions may be interpreted as steps of a method for generating an automated location-indicating response to a call. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for generating an automated location-indicating response, comprising:
receiving a call, transmitted from a caller device, at a callee mobile device; and
generating an automated response to the call, the response including location data that indicate a present location of the callee mobile device.

2. The method of claim 1 wherein the automated response includes image data from a camera that is operatively connected to the callee mobile device.

3. The method of claim 1 wherein the automated response includes a pre-drafted text message from a callee.

4. The method of claim 3 wherein the text message and the location data included in the response are selected based on an identity associated with the caller device.

5. The method of claim 3 wherein at least some of the location data are merged into the pre-drafted text message.

6. The method of claim 3 wherein data from an electronic calendar associated with the callee are merged into the pre-drafted text message.

7. The method of claim 1 wherein the automated response is generated at the callee mobile device after a predetermined time period or based on a callee unavailable flag.

8. The method of claim 1 wherein the location data are generated using both Geographic Information System (GIS) data and mobile positioning data and include the identity of a landmark near a present location of the callee mobile device.

9. The method of claim 1 wherein the location data are generated using both Geographic Information System (GIS) data and mobile positioning data and include an address near a present location of the callee mobile device.

10. The method of claim 1 further comprising the step of transmitting the response to an email address associated with the caller device.

11. A system in a mobile device for generating an automated location-indicating response, the system comprising:
a microprocessor; and
a memory operatively connected to the microprocessor, wherein the memory includes computer readable code for causing the microprocessor to:
generate an automated response to a received call, the response including location data that indicate a present location of the mobile device.

12. The system of claim 11 wherein the automated response includes image data from a camera that is operatively connected to the mobile device.

13. The system of claim 11 wherein the automated response includes a pre-drafted text message from a callee.

14. The system of claim 13 wherein the text message and the location data included in the response are selected based on an identity associated with a caller device.

15. The system of claim 13 wherein at least some of the location data are merged into the pre-drafted text message.

16. The system of claim 13 wherein data from an electronic calendar associated with the callee are merged into the pre-drafted text message.

17. The system of claim 13 wherein the automated response is generated at the mobile device after a predetermined time period or based on a callee unavailable flag.

18. The system of claim 11 wherein the location data are generated using both Geographic Information System (GIS) data and mobile positioning data and include the identity of a landmark near a present location of the mobile device.

19. The system of claim 11 wherein the location data are generated using both Geographic Information System (GIS) data and mobile positioning data and include an address near a present location of the mobile device.

20. The system of claim 11 wherein the memory includes computer readable code for causing the microprocessor to initiate transmission of the response to an email address associated with a caller device.

21. A system for generating an automated location-indicating response, comprising:
means for receiving a call, transmitted from a caller device, at a callee mobile device; and
means for generating an automated response to the call including location data that indicate a present location of the callee mobile device.
